(19) United States
(12) Patent Application Publication
(10) Pub. No.: US 2011/0309048 A1
(43) Pub. Date: Dec. 22, 2011

(54) HOLLOW BODY EQUIPPED WITH RELIEFS THAT ENABLE THE INDEXING THEREOF AND PROCESS FOR HANDLING SUCH A BODY

(75) Inventors: Arnaud Briard, Octeville sur Mer (FR); Nicolas Chomel, Octeville sur Mer (FR)

(73) Assignee: SIDEL PARTICIPATIONS, Octeville Sur Mer (FR)

(21) Appl. No.: 13/125,390

(22) PCT Filed: Oct. 20, 2009
(86) PCT No.: PCT/FR09/01226

§ 371 Date: Sep. 6, 2011

(30) Foreign Application Priority Data
Oct. 22, 2008 (FR) 0805858

(51) Int. Cl. B65D 1/02; B65G 47/74; B65B 7/28

(52) U.S. Cl. 215/44; 215/40; 198/339.1

(57) ABSTRACT

Hollow body extending along a principal axis and having a neck provided with a first relief suitable for allowing a predetermined angular indexing of the hollow body around its principal axis with respect to a device for gripping the hollow body. The neck having a second relief, axially offset with respect to the first relief, suitable for allowing a predetermined angular indexing of the hollow body around its principal axis with respect to a second gripping device superimposed on the first one.

The invention relates to hollow bodies and to the handling of hollow bodies. The expression “hollow bodies” designates not only containers: bottles, vials, jars, but also the blanks of containers from which they are obtained during manufacture: preforms or intermediate containers having undergone one or more preparatory operations (for example pre-blowing).

Containers made of plastic material are currently obtained by stretch-blowing of preforms. The preforms are generally cylindrical in shape, of circular section, and are obtained by injection. Although the body of the preform is intended to be deformed in a mold, the neck already has its final shape. The neck is provided at its base, at the junction with the body, with a collar the primary function of which is first to facilitate the gripping of the preform (particularly during heating operations, then for transfer to the mold), then of the container, (particularly during transfer, filling and capping operations).

The general shape of the container obtained does not necessarily have rotational symmetry. Indeed, it is common, for example, to seek to produce the effects of reliefs on the container, or to produce containers that are oval in shape.

It will be understood that in such cases, some areas of the preform must be stretched more in the radial direction during the stretch-blowing phase in the mold, and thus require further heating. To that end, preferential heating is applied to the preform, for example by means of heating elements producing a variable heating profile along the path of the preform, or by acting on the rotation of the preform in the oven.

It is then essential to maintain the angular position of the preform at the entry of the mold so that the preform is oriented in such a way as to allow the desired asymmetrical deformation during blowing.

It is known to carry out an angular indexing of the preform in the oven. For that purpose, the preform is provided, for example on its collar, with an indexing mark such as a stud or a notch suitable for cooperating with additional gripping means.

A first indexing technique consists, for example, of installing an optical sensor so as to detect an indexing mark provided on the preform. An example of this technique is given in the document EP 1 261 471. The mark is, for example, a stud or a notch or a colored dot. The preform placed in the mold then undergoes a rotation around its axis in order to bring the mark into a predetermined position, verified by the sensor. However, this technique is expensive to implement due to the use of precision optical instruments. Moreover, the pivoting of the preform in the mold slows down the rate of production.

A second technique consists of indexing the orientation of the preform by means of a relief placed at the level of the neck, to serve as an angular mark. The mold, for example a portfolio type, includes a relief in addition to the one of the neck of the preform. Thus, when the preform is placed in the mold, the closing of the mold causes the rotation of the preform until the reliefs cooperate, which ensures an automatic angular orientation. The document FR 2 874 193 describes this technique.

This second technique is less burdensome and has a precision at least equal to the first one. However, it does not make it possible to guarantee a correct orientation of the hollow bodies all along the path, and losses of orientation are noted in certain manufacturing lines, particularly when the manufacturing process requires multiple successive transfers while maintaining the angular orientation of the hollow bodies.

In particular, bumps or jerks can occur, which cause an undesirable angular displacement of the container.

The present invention seeks in particular to provide a solution to the various problems mentioned above. More specifically, the invention seeks to propose a solution making it possible to better control the angular position of the hollow bodies during their handling.

To that end, according to a first object, the invention proposes a hollow body extending along a principal axis and comprising a neck provided with a first relief suitable for allowing a predetermined angular indexing of the hollow body around its principal axis with respect to a device for gripping the hollow body, the neck comprising a second relief, axially offset with respect to the first relief, suitable for allowing a predetermined angular indexing of the hollow body around its principal axis with respect to a second gripping device superimposed on the first one.

According to the preferred embodiment, the first and second reliefs are axially aligned on the neck, facilitating the superposition of the gripping devices.

A relief comprises, for example, two symmetrically opposite elements, increasing the accuracy of the indexing.

According to the preferred embodiment, the reliefs are placed on the outer wall of the neck in order to facilitate their cooperation with the gripping devices.

According to one variation, the body is provided with a collar at the base of the neck, which collar comprises a relief suitable for allowing a preliminary angular indexing.

According to the preferred embodiment, the neck is threaded so as to cooperate with a complementary threading of a cap.

In this case, a relief comprises a salient element the height of which does not exceed that of the thread in order to allow the cap to pass over it. For example, the first relief is placed beneath the thread of the neck and the second relief is placed above the thread of the neck.

A relief can comprise a salient element on the neck, for example placed on a recessed portion in the neck, or a hollow element on the neck.

According to a second object, the invention proposes a method of handling a hollow body as described above, comprising the following steps:
indexing of the body in a first mold, provided with a first gripping device that is complementary to the first relief of the neck for a first operation;
gripping the body in the first mold by a transfer element provided with a second gripping device complementary to the second relief of the neck;
withdrawal of the first indexing device;
transfer of the hollow body from the first mold to a second mold by the transfer element in the same angular indexing position;
indexing of the body in the second mold, provided with a third gripping device that is complementary to the first relief of the neck for a second operation;
withdrawal of the second indexing device.

The first operation is, for example, a stretch-blowing operation and the second operation is, for example, a forming operation.

Other objects and advantages of the invention will be seen from the following description with reference to the appended drawings in which:

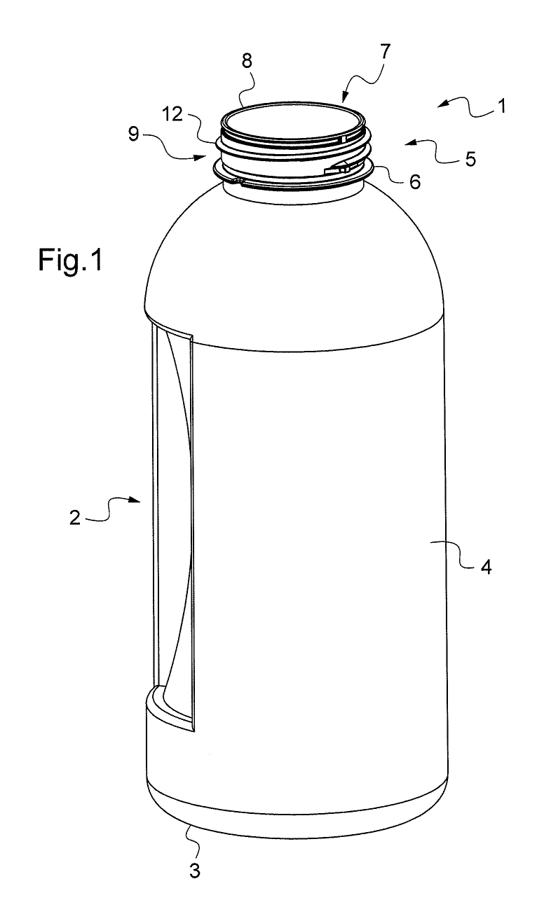

FIG. 1 is a view in perspective of a container according to the invention;

FIG. 2 is a detailed view in perspective, from above, of the neck of the container of FIG. 1;

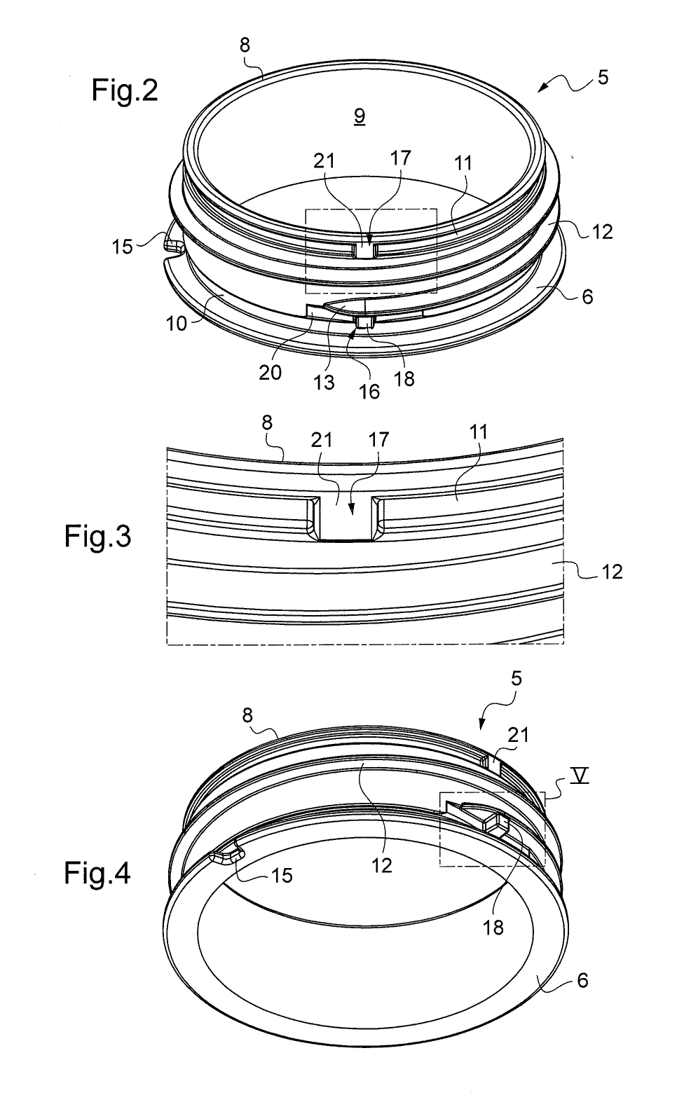

FIG. 3 is a detailed view, on an enlarged scale, of the neck shown in FIG. 2, showing a relief;

FIG. 4 is a detailed view in perspective, from below, of the neck of FIG. 2;

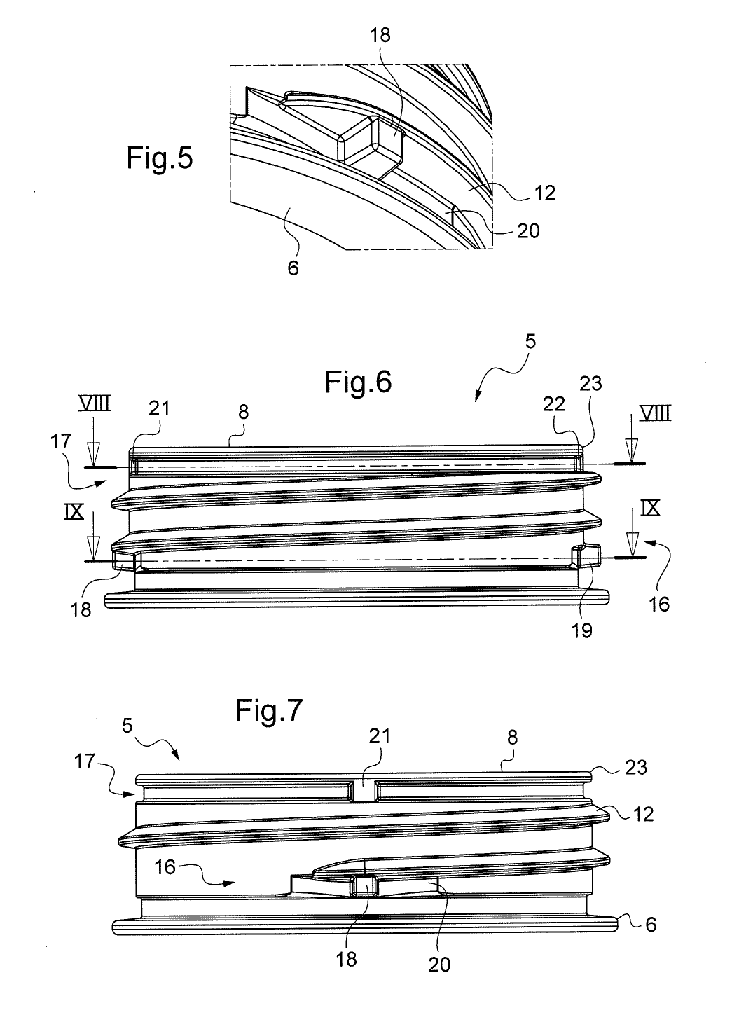

FIG. 5 is a detailed view, on an enlarged scale, of the neck shown in FIG. 4, showing another relief;

FIG. 6 is a side view of the neck of FIG. 2;

FIG. 7 is a view of the neck of FIG. 6, turned at a 90° angle;

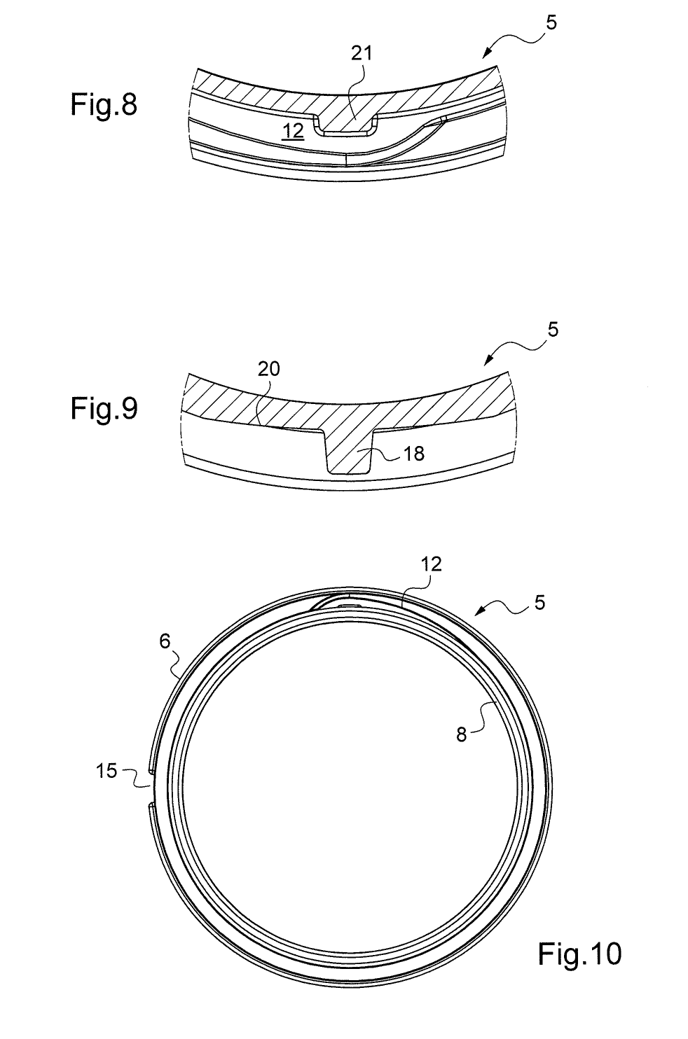

FIG. 8 is a cross-sectional view of the neck of FIG. 6, along the section plane VIII-VIII;

FIG. 9 is a cross-sectional view of the neck of FIG. 6, along the section plane IX-IX;

FIG. 10 is a top view of the neck of FIG. 2.

Represented in FIG. 1 is a hollow body 1, obtained by thermoforming, on which an indentation 2 has been made, for example to serve as a grip.

Here “hollow body” designates any body defining an internal environment opening out into an external environment.

The hollow body 1 comprises a bottom 3 from which side walls 4 extend up toward a neck 5, defining an opening of the hollow body 1. In general, the body 1 extends around a principal axis in such a way as to present an overall elongated shape, with, for example, a rotational symmetry like a cylinder. The hollow body 1 is made of thermoplastic material, for example, such as polypropylene terephthalate or polypropylene. The hollow body 1 can be intended to serve as a container, such as a bottle, suitable for receiving liquids for human consumption, such as water, milk, or fruit juice or solid foods or medicines. It can also act as a preform or an intermediate container produced from an incomplete transformation of a preform and intended to undergo one or more transformation operations in order to obtain a final container.

The hollow body 1 in this instance is a container obtained from a preform heated then formed by stretch-blowing in a mold, according to a known process.

At its junction with the body 1, the neck 5 is provided with a radially salient annular collar 6. At its upper end 7, the neck 5 defines a wide mouth 8.

The neck 5 has a cylindrical central section 9, bordered on the side of the collar 6 by a lower annular groove 10, and on the side of the wide mouth 8, by an upper annular groove 11 hollowed out of the thickness of the neck 5.

In order to allow the screwing of a cap onto the hollow body 1, the neck 5 is provided with a helicoidal thread 12 that protrudes from the outer surface of the central section 9 and stops, near the lower groove 10, at a beveled lower end 13 and, near the upper groove 11, at an upper beveled end 14. The pitch of the thread 12 will be chosen based on the capping stresses applicable to the hollow body 1.

The collar 6 is provided at its periphery with a notch 15 capable of allowing an angular indexing of the hollow body 1 during or upon completion of a heating operation. Said notch 15 is provided in order to receive an indexing pin, the insertion of which into the notch 15 causes the hollow body 1 to be blocked in rotation in a predetermined angular position corresponding to the angular position of the notch 15 on the collar 6.

Moreover, as is illustrated in the figures, the neck 5 is provided with at least two reliefs, to with:
a first relief, called lower relief 16, suitable for allowing a predetermined angular indexing of the hollow body 1 around its principal axis with respect to a first device for gripping the hollow body 1, and
a second relief, called upper relief 17, axially offset with respect to the lower relief 16, suitable for allowing a predetermined angular indexing of the hollow body 1 around its axis with respect to a second gripping device different from the first one, and superposed over it.

A relief here designates any irregularity on the surface of the neck. Thus, protruding elements, such as studs, as well as hollowed areas, such as notches, are considered reliefs.

In the embodiment illustrated in the figures, the reliefs 16 and 17 are in the form of studs protruding radially from the surface of the neck.

More specifically, the neck 5 comprises two lower studs 18 and 19 located axially at the same level and diametrically opposite. The lower studs 18 and 19 are located on the side of the collar 6. More specifically, the lower studs 18 and 19 protrude from the surface of the main section 9 of the neck 5, between the lower end 13 of the thread 12 and the lower groove 10.

The lower studs 18 and 19 have a radial extension (or height) such that they do not extend radially past the thread 12, so as not to prevent capping. In practice, the lower studs 18 and 19 have an outer radial face that is located radially at the same level as a crest of the thread 12.

The lower studs 18 and 19 have a radial extension of between 1° and 2°. Moreover, in order to increase their apparent radial extension, or in other words to increase their lateral surface for gripping by a gripping device, the surface of the principal section 9 of the neck 5 is hollowed out at the foot of the lower studs 18 and 19. More specifically, on either side of each stud 18 and 19, at the same axial level thereof, the surface of the principal section of the neck is provided with two flat spots 20 each of which extends angularly approximately 5° to 10° over the circumference of the neck 5.

The neck 5 further comprises two upper studs 21 and 22 located axially at the same level and diametrically opposite. The upper studs 21 and 22 are axially offset and can be angularly aligned with respect to the lower studs 18 and 19, as is represented in the figures. According to one variation, the upper studs 21 and 22 are also angularly offset with respect to the lower studs 18 and 19.

More specifically, the upper studs 21 and 22 are located in the upper groove, and extend radially from the bottom thereof to a height equal to the depth of the groove 11. The upper studs 21 and 22 have a radial outer face that extends in the extension both of an annular lateral face 23 of the wide mouth 8 and of the outer face of the principal section 9 of the neck 5.

Like the lower studs 18 and 19, the upper studs 21 and 22 have a radial extension of between 1° and 2°. According to one embodiment, the upper studs 21 and 22 are angularly offset by 90° with respect to the lower studs.

As we have seen, the lower studs 18 and 19 and the upper studs 21 and 22 are provided to allow a double angular indexing of the hollow body 1 with respect to a first gripping device cooperating with the lower studs 18 and 19, and with respect to a second gripping device different from the first one and superimposed thereon.

Each gripping device comprises, for example, two parts that are movable with respect to each other, which are articulated with respect to a joint plane. The gripping device includes means for holding the hollow body and an upper face above which the neck 5 extends at least partially. According to a first embodiment, the two parts are articulated around a common axis like tongs. According to a second embodiment, the two parts are moved in translation with respect to each other.

In both embodiments, the gripping device can take two positions:
in an open position, the two parts are separated from each other with respect to the joint plane;
in a closed position, the two parts are brought together against each other along the joint plane.

Each gripping device includes elements of a shape complementary to that of the reliefs 16 and 17, so as to cooperate therewith. Thus, when the relief is a salient element, the gripping device comprises a complementary hollow element. Conversely, when the relief is hollow, the gripping device comprises a complementary salient element.

Thus, when the gripping device is closed onto the hollow body 1, the hollow reserves (respectively the studs) cooperate with the reliefs 16 and 17 (studs or, respectively, hollow reserves) of the neck 5.

It will be understood that the hollow body 1 thus held by a gripping device is blocked in rotation around its principal axis, with a working clearance of between ±1° and ±10°, depending on the tolerances.

Thus, the lower studs 18 and 19 allow gripping, at the exit of the oven of the preform by means of the first gripping device (for example, a mold or opening/closing of the portfolio or linear type) with an angular indexing of ±3°, at the exit of the oven where the angular indexing was ±10°.

Then, once the container is formed from the preform, a second gripping device in the form of tongs grasps the container thus formed maintaining the angular indexing by means of the upper studs 21 and 22, the precision of the indexing being able to be greater than that of the first gripping device, for example on the order of ±1°.

In practice, in the manufacture of containers as a result of the presence of two reliefs 16 and 17 or series of reliefs axially offset on the neck, the hollow body 1 can preserve a precise indexing obtained in a first mold during a first operation, typically stretch-blowing to form a container from a preform, in order to carry out a second operation within a second mold, typically forming or boxing.

In practice, the mold forming the first gripping device can take two positions: an open position in which the two half-molds are separated from each other; and a closed position in which the half-molds are brought together against each other at a joint plane, thus defining a cavity. The cavity of the mold opens on an upper surface, on which a gripping device is placed. More specifically, each half-mold carries one part of the gripping device, the joint plane of the mold corresponding to that of the gripping device.

The hollow body 1 is first taken by means of transportation between the half-molds of a first open mold. Generally, said means of transportation grasps the hollow body 1 by its neck 5. The mold is closed onto the hollow body 1 so that the neck 5 protrudes from the cavity, the collar 6 resting on the upper surface of the mold. During the closing of the mold, the elements of the gripping device engage around the lower relief 16, thus orienting the hollow body 1 in the desired angular position and maintaining it in that position inside the mold. The upper relief 17 then remains free outside of the mold, which allows it to be gripped by the second gripping device while the hollow body 1 is still held by the first device, particularly when the hollow body 1 must undergo a second operation, for example forming in a second mold, and the body 1 must be transferred into said second mold.

The second gripping device then comes into contact with the neck 5, by cooperating with the upper relief 17. When the first mold opens, the hollow body 1 thus preserves its angular indexing in, then throughout, its transfer to the second mold. The hollow body 1 is then placed therein, the angular indexing of the hollow body 1 being maintained.

The indexing of the hollow body 1 on two levels thus makes it possible to perpetuate the precision of the angular orientation of the hollow body 1 during its handling, irrespective of the number of successive operations the body 1 must undergo.

It should be noted that the angular position of the studs 18, 19, 21, 22 can be selected so as to contribute additional functionalities. Thus, placed to the right of the lower end 13 of the thread 12, one of the lower studs 18 and 19 can be used for security, for example for the opening of the cap. Indeed, in order to close the cap on the neck 5, the thread of the cap must go beyond the stud. Then, in order to open the cap, extra effort must be made to make the thread of the cap pass the first element, preventing an accidental opening, for example by a young child.

The indexing on two levels on the neck 5 of the hollow body 1 thus makes it possible to preserve the precision of indexing during the transfer of the hollow body 1 between two operations.

Producing the reliefs 16 and 17 on the neck 5 is simple and requires little or no additional material.

From an aesthetic point of view, the reliefs described above remain discreet and do not modify the end use of the hollow body 1, whether it involves pouring out the liquid contained in the hollow body 1 or drinking the contents directly therefrom. Moreover, the presence of the reliefs 16 and 17 does not slow production rate in any way.

1. Hollow body extending along a principal axis and comprising a neck provided with a first relief suitable for allowing a predetermined angular indexing of the hollow body around its principal axis with respect to a device for gripping the hollow body, said hollow body being characterized in that the neck comprises a second relief, axially offset with respect to the first relief, suitable for allowing a predetermined angular indexing of the hollow body around its principal axis with respect to a second gripping device superimposed on the first one.

2. Hollow body according to claim 1, wherein the first and second reliefs are axially aligned on the neck.

3. Hollow body according to claim 1, wherein a relief comprises two symmetrically opposite elements.

4. Hollow body according to claim 1, wherein the reliefs are placed on the outer wall of the neck.

5. Hollow body according to claim 1, provided with a collar at the base of the neck, which collar comprises a relief suitable for allowing a preliminary angular indexing.

6. Hollow body according to claim 1, wherein the neck is threaded.

7. Hollow body according to claim 6, wherein a relief comprises a salient element the height of which does not exceed that of the thread.

8. Hollow body according to claim 6, wherein the first relief is placed beneath the thread of the neck.

9. Hollow body according to claim 6, wherein the second relief is placed below the thread of the neck.

10. Hollow body according to claim 1, wherein a relief comprises a salient element on the neck.

11. Hollow body according to claim 10, wherein the salient element is placed on a recessed portion in the neck.

12. Hollow body according to claim 1, wherein a relief comprises a recessed element on the neck.

13. Method of handling a hollow body according to claim 1, comprising the following steps:
indexing of the body in a first mold, provided with a first gripping device that is complementary to the first relief of the neck, for a first operation;
gripping the body in the first mold by a transfer element provided with a second gripping device complementary to the second relief of the neck;
withdrawal of the first indexing device;
transfer of the hollow body from the first mold to a second mold by the transfer element in the same angular indexing position;
indexing of the body in the second mold, provided with a third gripping device that is complementary to the first relief of the neck, for a second operation;
withdrawal of the second indexing device.

14. Method of handling a hollow body according to claim 13, wherein the first operation is a stretch-blowing operation and the second operation is a forming operation.
